(19) United States
(12) Patent Application Publication
(10) Pub. No.: US 2024/0302710 A1
(43) Pub. Date: Sep. 12, 2024

(54) LENS BARREL AND IMAGING DEVICE

(71) Applicant: NIKON CORPORATION, Tokyo (JP)

(72) Inventors: Azusa MUTO, Kawasaki-shi (JP); Kazutoshi USUI, Kawasaki-shi (JP)

(73) Assignee: NIKON CORPORATION, Tokyo (JP)

(21) Appl. No.: 18/269,230

(22) PCT Filed: Dec. 20, 2021
(86) PCT No.: PCT/JP2021/047060

§ 371 Date: Jun. 22, 2023

(30) Foreign Application Priority Data
Dec. 25, 2020 (JP) 2020-217240

(51) Int. Cl. G03B 5/00; G02B 7/04

(52) U.S. Cl. CPC G03B 5/00; G02B 7/04; G03B 2205/0069

(57) ABSTRACT

To increase the amount of movement of a lens driven by a voice coil motor, a lens barrel includes a first yoke and a second yoke each having a length in an optical axis direction, a third yoke that has a length in the optical axis direction and is disposed between the first yoke and the second yoke, a first magnet disposed on the first yoke, a second magnet disposed on the second yoke, a coil that is penetrated by the third yoke and is movable in the optical axis direction by magnetic forces of the first magnet and the second magnet, and a lens holding frame that holds a lens and is movable together with the coil in the optical axis direction, and the third yoke has a groove along the optical axis direction.

### TECHNICAL FIELD

The present disclosure relates to a lens barrel and an imaging device.

### BACKGROUND ART

A lens barrel employing a voice coil motor as a lens driving device has been proposed (for example, Patent Document 1). Miniaturization of voice coil motors is desired.

### PRIOR ART DOCUMENT

### Patent Document

Patent Document 1: Japanese Patent Application Laid-Open No. 2015-49334

### SUMMARY OF THE INVENTION

According to a first aspect, there is provided a lens barrel including: a first yoke and a second yoke each having a length in an optical axis direction; a third yoke that has a length in the optical axis direction and is disposed between the first yoke and the second yoke; a first magnet disposed on the first yoke; a second magnet disposed on the second yoke; a coil that is penetrated by the third yoke and is movable in the optical axis direction by magnetic forces of the first magnet and the second magnet; and a lens holding frame that holds a lens and is movable together with the coil in the optical axis direction, wherein the third yoke has a groove along the optical axis direction.

According to a second aspect, there is provided an imaging device including the above lens barrel.

The configurations of the embodiments described below may be appropriately modified, and at least one of the components may be replaced with another component. Furthermore, constituent elements whose arrangement is not particularly limited are not limited to the arrangement disclosed in the embodiment, and can be arranged at positions where their functions can be achieved.

### BRIEF DESCRIPTION OF THE DRAWINGS

FIG. 1 is a diagram illustrating a camera including a lens barrel in accordance with an embodiment and a camera body;

FIG. 2A is a perspective view illustrating a configuration of a voice coil motor, and FIG. 2B is a view of the voice coil motor as viewed from a direction indicated by an arrow AR1 in FIG. 2A;

FIG. 3A is a cross-sectional view taken along line A-A in FIG. 1, and FIG. 3B is a view in which illustration of the coil is omitted in FIG. 3A;

FIG. 4 is a cross-sectional view taken along line B-B in FIG. 3A;

FIG. 5A and FIG. 5B are diagrams for describing a configuration of a lens holding frame in accordance with a comparative example;

FIG. 6A and FIG. 6B are diagrams for describing a movable range of the coil;

FIG. 7A is a perspective view illustrating a configuration of a voice coil motor in accordance with a first variation, and FIG. 7B is a view of the voice coil motor as viewed from a direction indicated by an arrow AR11 in FIG. 7A;

FIG. 8 is a diagram for describing a movable range of a coil in the voice coil motor of the first variation; and

FIG. 9 is a front view illustrating a schematic configuration of a voice coil motor in accordance with a second variation.

### MODES FOR CARRYING OUT THE INVENTION

Hereinafter, a lens barrel 100 in accordance with an embodiment will be described in detail with reference to the drawings. In each drawing, illustration of some elements may be omitted in order to facilitate understanding.

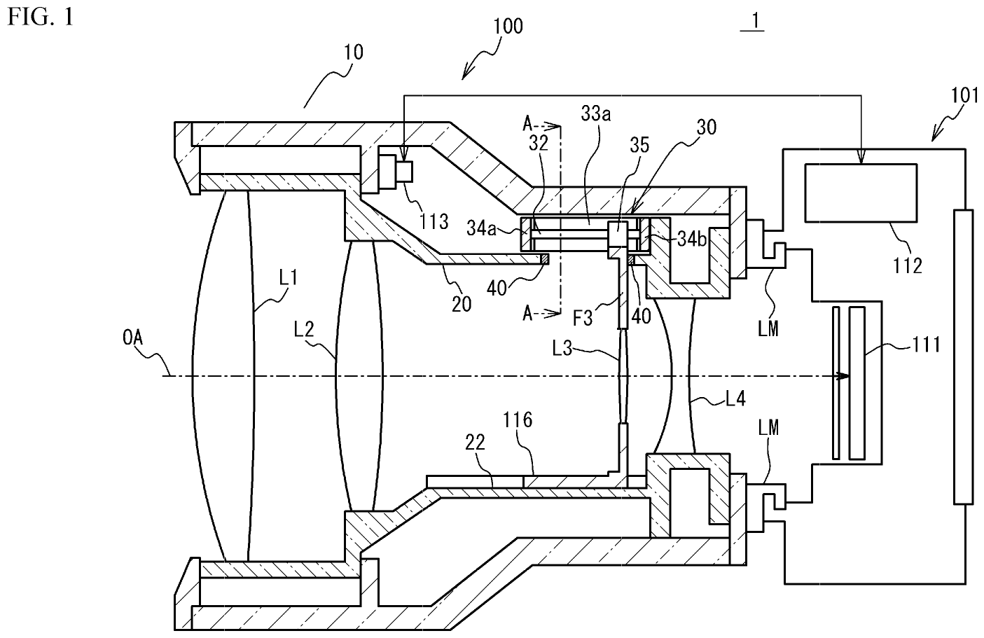

FIG. 1 is a diagram illustrating a camera 1 including the lens barrel 100 in accordance with the present embodiment and a camera body 101. In the present embodiment, the lens barrel 100 is attachable to and detachable from the camera body 101, but this does not intend to suggest any limitation, and the lens barrel 100 and the camera body 101 may be integrated.

The camera body 101 includes an image sensor 111, a control unit 112, and the like inside. The image sensor 111 includes a photoelectric conversion element such as a charge coupled device (CCD), and converts a subject image formed by the imaging optical system (the lens barrel 100 attached to the camera body 101) into an electric signal.

The control unit 112 includes a central processing unit (CPU) and the like, and integrally controls operations of the camera 1 related to photographing including focus driving in the camera body 101 and the attached lens barrel 100 as a whole.

As illustrated in FIG. 1, the lens barrel 100 in accordance with the present embodiment includes a first fixed barrel 10 and a second fixed barrel 20 disposed radially further inward than the first fixed barrel 10. In the present embodiment, the first fixed barrel 10 is composed of a plurality of components, but may be composed of one component. As illustrated in FIG. 1, a lens mount LM that allows the lens barrel 100 to be attached to and detached from the camera body 101 is fixed to the first fixed barrel 10.

Further, the lens barrel 100 includes a plurality of lenses L1 to L4 sequentially arranged along the common optical axis OA. The lens L3 is held by a lens holding frame F3, and the other lenses are held by the second fixed barrel 20. Each of the lenses L1 to L4 may composed of a plurality of lenses.

In the present embodiment, the lens L3 is a focus lens and is moved in the optical axis direction to adjust the focus. The lens L3 is provided so as to be moved in the optical axis direction by a voice coil motor (VCM) 30 disposed inside the lens barrel 100.

The lens holding frame F3 includes an engaging portion 116 protruding in a direction intersecting the optical axis OA. The engaging portion 116 engages with a straight groove 22 of the second fixed barrel 20. The straight groove 22 extends in the optical axis direction. Thus, rotation of the lens holding frame F3 around the optical axis OA is restricted, and the lens holding frame F3 is guided by the straight groove 22 to move straight in the optical axis direction. The lens holding frame F3 may be guided in the optical axis direction not by the straight groove 22 but by a guide bar extending in the optical axis direction.

The VCM 30 is driven by a drive device 113. The drive device 113 controls focus driving of the lens L3 under the control by the control unit 112 of the camera body 101. Specifically, the drive device 113 generates a drive signal for the VCM 30 based on the position information of the lens L3 input from a position detection mechanism (not illustrated) such as an optical encoder or magnetic encoder and the target position information of the lens L3 input from the control unit 112 of the camera body 101, and outputs the generated drive signal to the VCM 30.

The VCM 30 linearly drives the lens L3 in the optical axis direction according to the drive signal. Although details will be described later, as illustrated in FIG. 1, the lens holding frame F3 is connected to a coil 35 provided in the VCM 30. Thus, when the coil 35 is linearly driven in the optical axis direction, the lens holding frame F3 is linearly driven in the optical axis direction, and the position of the lens L3 in the optical axis direction is changed.

When the drive signal for the VCM 30 is OFF, the coil 35 of the VCM 30 does not have a holding force to maintain its position, and thus moves freely. Therefore, when the lens barrel 100 is oriented upward or downward, the coil 35 may move due to the weights of the lens holding frame F3 and the lens L3, and the lens holding frame F3 may collide with the second fixed barrel 20 and generate an impact sound. Therefore, as illustrated in FIG. 1, a cushioning member 40 is provided in a portion of the second fixed barrel 20 overlapping the lens holding frame F3 in the optical axis direction. As a result, the lens holding frame F3 collides with the cushioning member 40, and thereby the impact is reduced and the impact sound is reduced.

In the camera 1 including the camera body 101 and the lens barrel 100 as described above, when a shutter button (not illustrated) is pressed (a release operation or a focusing operation is performed), the control unit 112 in the camera body 101 performs control such as focus driving of the lens barrel 100 through the drive device 113. The image sensor 111 converts light of a subject image formed by the lens barrel 100 into an electric signal, and the image data is recorded in a memory (not illustrated) provided in the camera body 101 (that is, shooting is performed).

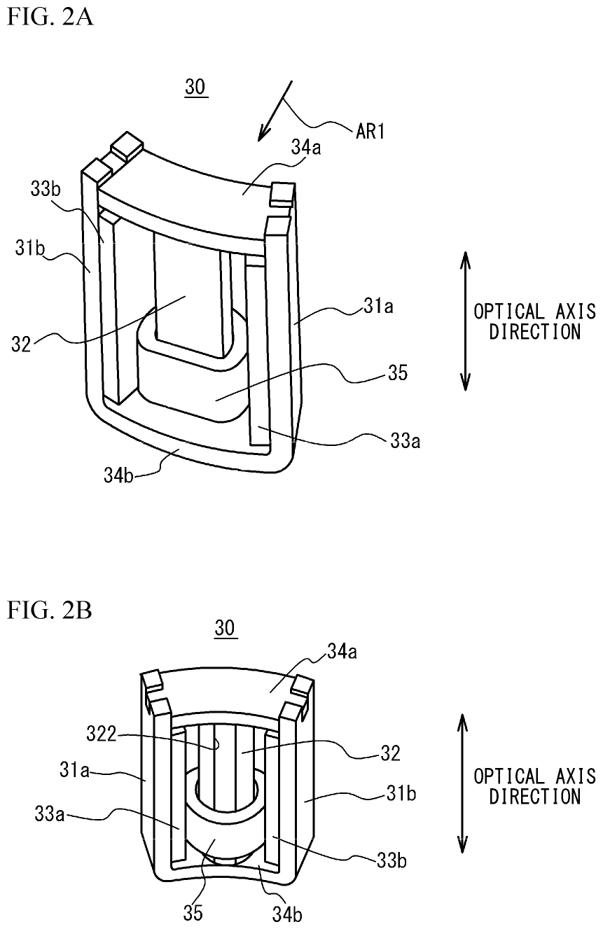

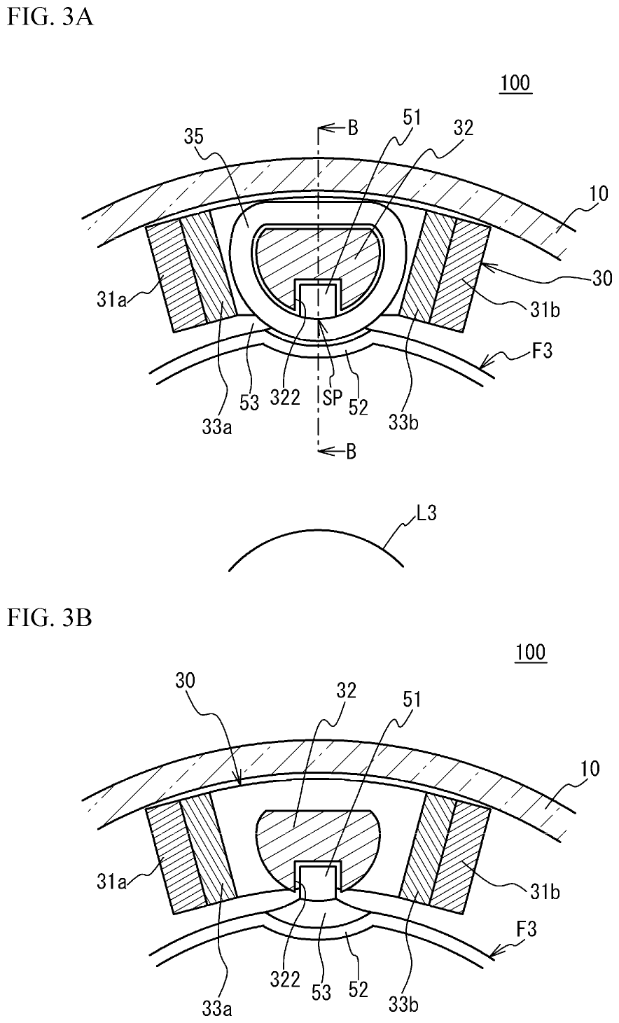

Next, the configuration of the VCM 30 that drives the lens L3 is described. FIG. 2A is a perspective view illustrating the configuration of the VCM 30, and FIG. 2B is a view of the VCM 30 as viewed from the direction indicated by an arrow AR1 in FIG. 2A. FIG. 3A is a cross-sectional view taken along line A-A in FIG. 1, and FIG. 3B is a view in which illustration of the coil 35 is omitted in FIG. 3A.

As illustrated in FIG. 2A and FIG. 2B, the VCM 30 in accordance with the present embodiment includes a first side yoke 31a and a second side yoke 31b each having a length in the optical axis direction, and a center yoke 32 that has a length in the optical axis direction and is disposed between the first side yoke 31a and the second side yoke 31b.

As illustrated in FIG. 2B, the center yoke 32 has a groove 322 along the optical axis direction. In the present embodiment, as illustrated in FIG. 3A, the center yoke 32 has the groove 322 at the side where the lens 3 is disposed. In other words, the groove 322 opens toward the lens L3.

The VCM 30 also includes an upper yoke 34a connecting first ends of the first side yoke 31a, the second side yoke 31b, and the center yoke 32 in the optical axis direction, and a lower yoke 34b connecting second ends of the first side yoke 31a, the second side yoke 31b, and the center yoke 32. This structure forms a closed magnetic circuit.

A first magnet 33a is disposed on a side surface at the center yoke 32 side of the first side yoke 31a, and a second magnet 33b is disposed on a side surface at the center yoke 32 side of the second side yoke 31b.

For example, the first magnet 33a is disposed so that the side closer to the center yoke 32 is the north pole, and the second magnet 33b is also disposed so that the side closer to the center yoke 32 is the north pole. This structure forms a magnetic path in which magnetic fluxes enter the center yoke 32 from the north poles of the first magnet 33a and the second magnet 33b, pass through the upper yoke 34a and the lower yoke 34b and the first side yoke 31a and the second side yoke 31b, and return to the south poles of the first magnet 33a and the second magnet 33b, respectively.

The VCM 30 includes the coil 35 penetrated by the center yoke 32. As illustrated in FIG. 3A, the coil 35 of the VCM 30 in the present embodiment has a substantially D shape. The starting point SP of the winding of the coil 35 is opposite the groove 322 of the center yoke 32. Thus, the conductive wire extending from the starting point SP of the winding of the coil 35 can be led out to the outside of the coil 35 without being sandwiched between the coil 35 and the center yoke 32.

In addition, conductive wires led out from the coil 35 (a conductive wire extending from the starting point of the winding and a conductive wire extending from the ending point of the winding) are connected to a substrate (for example, a flexible printed circuit (FPC) attached to the lens holding frame F3. The lens holding frame F3 and the coil 35 move together. By connecting the conductive wires led out from the coil 35 to the substrate on the lens holding frame F3, it is possible to prevent the conductive wire (wiring) from being broken due to a load applied to the conductive wire caused by loosening or tensioning of the conductive wire with the movement of the coil 35.

A drive signal (current) is input to the coil 35 from the drive device 113 (see FIG. 1) provided in the lens barrel 100. When a current flows through the coil 35, the coil 35 moves in the optical axis direction due to the magnetic forces of the first magnet 33a and the second magnet 33b. More specifically, the coil 35 is moved in the optical axis direction by electromagnetic interaction between the coil 35 through which the current flows and the first magnet 33a and the second magnet 33b. By changing the direction of the current flowing through the coil 35, the moving direction of the coil 35 can be switched between the subject side and the camera body 101 side. Further, the driving force and the moving speed of the coil 35 can be changed by changing the value of the current flowing through the coil 35.

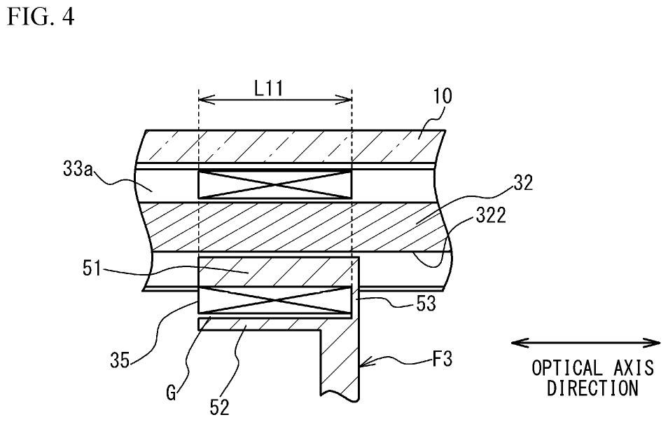

Next, the connection between the lens holding frame F3 and the coil 35 will be described. FIG. 4 is a cross-sectional view taken along line B-B in FIG. 3A.

As illustrated in FIG. 3A, FIG. 3B, and FIG. 4, the lens holding frame F3 includes a first portion 51 located inside the coil 35 and a second portion 52 that is located outside the coil 35 and sandwiches the coil 35 between the first portion 51 and the second portion 52. The first portion 51 is disposed in the groove 322 of the center yoke 32 and is movable in the optical axis direction. Since the center yoke 32 has the groove 322, even if the first portion 51 is disposed inside the coil 35, the first portion 51 can move without mechanically interfering with the center yoke 32.

As illustrated in FIG. 3A and FIG. 4, the first portion 51 is in contact with the inner peripheral surface of the coil 35. Since the coil 35 generally starts to be wound from the inner side, the outer side expands. Therefore, if the outer peripheral surface of the coil 35 and the lens holding frame F3 are positioned so as to be in contact with each other at the time of assembly, the coil 35 and the lens holding frame F3 may not be accurately positioned. On the other hand, the inner peripheral surface of the coil 35 expands less than the outer peripheral surface and has higher precision. Therefore, in the present embodiment, the first portion 51 located inside the coil 35 is in contact with the inner peripheral surface of the coil 35. As a result, the positional relationship between the coil 35 and the lens holding frame F3 can be arranged more precisely than in the case where the outer peripheral surface of the coil 35 is used. The lens holding frame F3 and the coil 35 can be coupled to each other by filling a clearance G (see FIG. 4) between the second portion 52 and the coil 35 with an adhesive in a state where the first portion 51 is in contact with the inner peripheral surface of the coil 35.

As illustrated in FIG. 4, the first portion 51 and the second portion 52 are connected to each other by a connection portion 53. The connection portion 53 that connects the first portion 51 and the second portion 52 is located at one end side of the lens holding frame F3 in the optical axis direction. This makes it possible to increase the movable range of the coil 35 in the optical axis direction. This point will be further described.

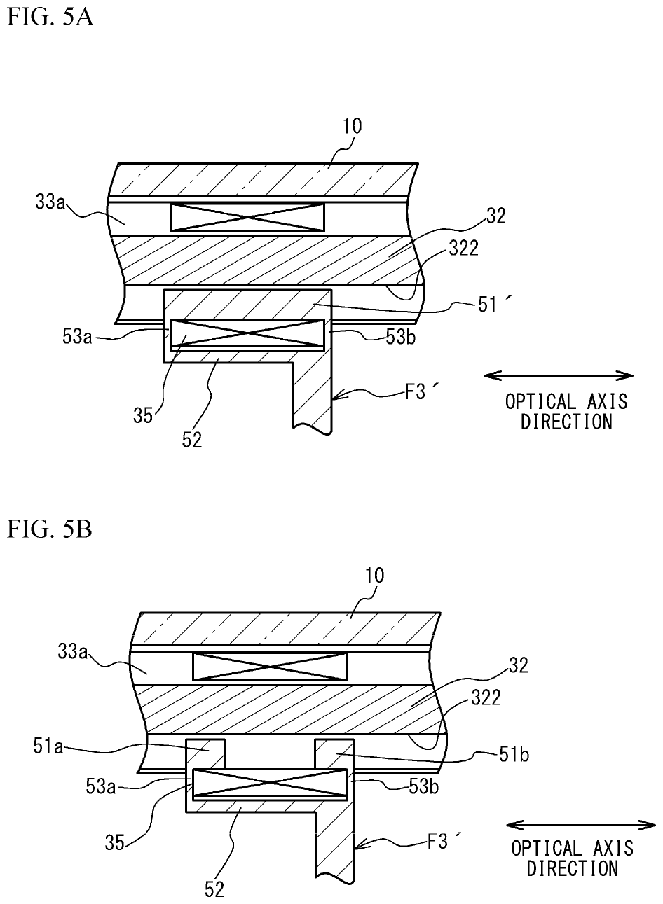

FIG. 5A and FIG. 5B are cross-sectional views illustrating a lens holding frame F3′ in accordance with a comparative example. In FIG. 5A, connection portions 53a and 53b that connect a first portion 51′ and the second portion 52 are provided at respective ends of the lens holding frame F3′ in the optical axis direction. In FIG. 5B, at one end side of the lens holding frame F3′ in the optical axis direction, a first portion 51a and the second portion 52 are connected by the connection portion 53a, and at the other end side, a first portion 51b and the second portion 52 are connected by the connection portion 53b.

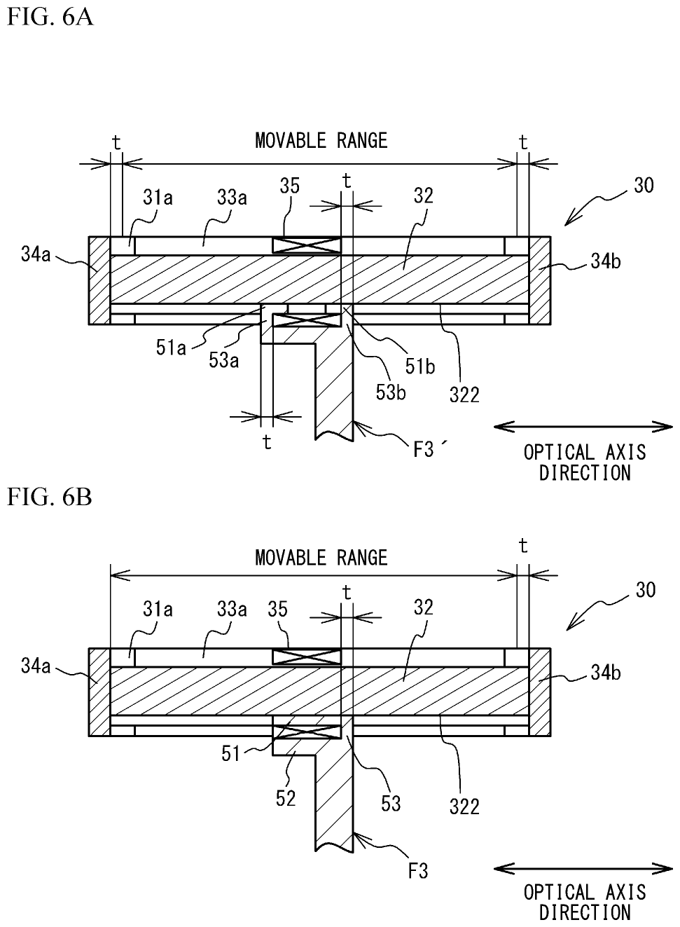

The coil 35 moves between the upper yoke 34a and the lower yoke 34b in the optical axis direction. However, in the comparative example, the connection portion 53a or 53b comes into contact with the upper yoke 34a or the lower yoke 34b before the end surface of the coil 35 in the optical axis direction comes into contact with the upper yoke 34a or the lower yoke 34b. Therefore, in the comparative example, as illustrated in FIG. 6A, the movable range of the coil 35 is a range obtained by subtracting the thicknesses t of the connection portions 53a and 53b in the optical axis direction from the distance between the upper yoke 34a and the lower yoke 34b in the optical axis direction.

In contrast, in the present embodiment, the connection portion 53 is provided at one end side of the lens holding frame F3 in the optical axis direction and is not provided at the other end side. Therefore, as illustrated in FIG. 6B, the movable range of the coil 35 can be made longer than that of the comparative example in which the connection portions 53a and 53b are provided at respective ends, by the thickness of the connection portion 53a in the optical axis direction.

As illustrated in FIG. 4, in the present embodiment, the length L11 of the first portion 51 in the optical axis direction is substantially the same as the length of the coil 35 in the optical axis direction. Alternatively, the length L11 of the first portion 51 in the optical axis direction is shorter than the length of the coil 35 in the optical axis direction. That is, the first portion 51 does not protrude from the coil 35 in the optical axis direction. This prevents the first portion 51 from coming into contact with the upper yoke 34a or the lower yoke 34b before the coil 35, thereby preventing the movable range of the coil 35 from being narrowed.

As described above in detail, according to the present embodiment, the lens barrel 100 includes the first side yoke 31a and the second side yoke 31b each having a length in the optical axis direction, the center yoke 32 that has a length in the optical axis direction and is disposed between the first side yoke 31a and the second side yoke 31b, the first magnet 31a disposed on the first side yoke 33a, the second magnet 33b disposed on the second side yoke 31b, the coil 35 that is penetrated by the center yoke 32 and is movable in the optical axis direction by the magnetic forces of the first magnet 33a and the second magnet 33b, and the lens holding frame F3 that holds the lens and is movable in the optical axis direction together with the coil 35. The center yoke 32 has the groove 322 along the optical axis direction. Since the groove 322 is provided, even when the first portion 51 for connecting the coil 35 and the lens holding frame F3 is disposed inside the coil 35, the first portion 51 does not mechanically interfere with the center yoke 32. Therefore, there is no need to secure an extra space between the coil 35 and the center yoke 32 in order to dispose the first portion 51, and the distance between the center yoke 32 and the lens L3 in the radial direction of the lens L3 can be shortened. Therefore, the diameter of the lens barrel 100 can be reduced, and the size of the lens barrel 100 can be reduced. The center yoke 32 is lighter than the center yoke without the groove 322, so the VCM 30 and thus the lens barrel 100 can be made lighter.

Further, in the present embodiment, the center yoke 32 has the groove 322 at the side where the lens L3 is disposed. This structure allows the first portion 51 for connecting the coil 35 and the lens holding frame F3 to be disposed near the lens holding frame F3, and thereby the lens holding frame F3 can be stably connected to the coil 35.

In the present embodiment, the lens holding frame F3 includes the first portion 51 located inside the coil 35 and the second portion 52 that is located outside the coil 35 and sandwiches the coil 35 between the first portion 51 and the second portion 52. The first portion 51 is disposed in the groove 322 and is movable in the optical axis direction along the groove 322. Since the first portion 51 for connecting the coil 35 and the lens holding frame F3 is disposed in the groove 322, the distance between the center yoke 32 and the lens L3 in the radial direction of the lens L3 can be shortened, and the diameter of the lens barrel 100 can be reduced. Thus, the lens barrel 100 can be miniaturized.

In the present embodiment, the first portion 51 is in contact with the inner peripheral surface of the coil 35. Since the coil 35 is wound from the inner side, the winding wires overlap at the outer side and the coil 35 expands. Therefore, by making the first portion 51 in contact with the inner peripheral surface of the coil 35, which is more precise, the coil 35 can be precisely installed at the designated position.

In addition, in the present embodiment, the lens holding frame F3 includes the connection portion 53 that connects the first portion 51 and the second portion 52, and the connection portion 53 is positioned at one end side of the lens holding frame F3 in the optical axis direction. The other end side of the lens holding frame F3 in the optical axis direction does not have the connection portion 53. Thus, the movable range of the coil 35 in the optical axis direction can be made longer than that in the case where the connection portions 53 are located at respective ends of the lens holding frame F3 in the optical axis direction. That is, it is possible to increase the amount of movement in the optical axis direction of the lens L3 moved by the VCM 30.

In the present embodiment, the length of the first portion 51 in the optical axis direction is shorter than the length of the coil 35 in the optical axis direction. This prevents the first portion 51 from coming into contact with the upper yoke 34a or the lower yoke 34b before the coil 35, so that the movable range of the coil 35 in the optical axis direction can be increased as compared with the case where the length of the first portion 51 in the optical axis direction is longer than that of the coil 35.

In the present embodiment, the starting point SP of the winding (see FIG. 3A) of the coil 35 faces the groove 322. Thus, the conductive wire extending from the starting point SP of the winding of the coil 35 can be led out to the outside of the coil 35 without being sandwiched between the coil 35 and the center yoke 32.

Further, in the present embodiment, the conductive wire led out from the coil 35 is connected to a substrate attached to the lens holding frame F3. This prevents the conductive wire (wiring) from being broken due to a load applied to the conductive wire caused by loosening or tensioning of the conductive wire with the movement of the coil 35.

In the above embodiment, the center yoke 32 has the groove 322 at the side where the lens L3 is disposed, but the groove 322 may be provided at another position. For example, the center yoke 32 may have the groove 322 at the side where the first fixed barrel 10 is disposed, or may have the groove 322 at the side where the first side yoke 31a or the second side yoke 31b is disposed. In this case, since the first portion 51 is disposed in the groove 322, the connection portion 53 may have a ring shape surrounding the center yoke 32.

### First Variation

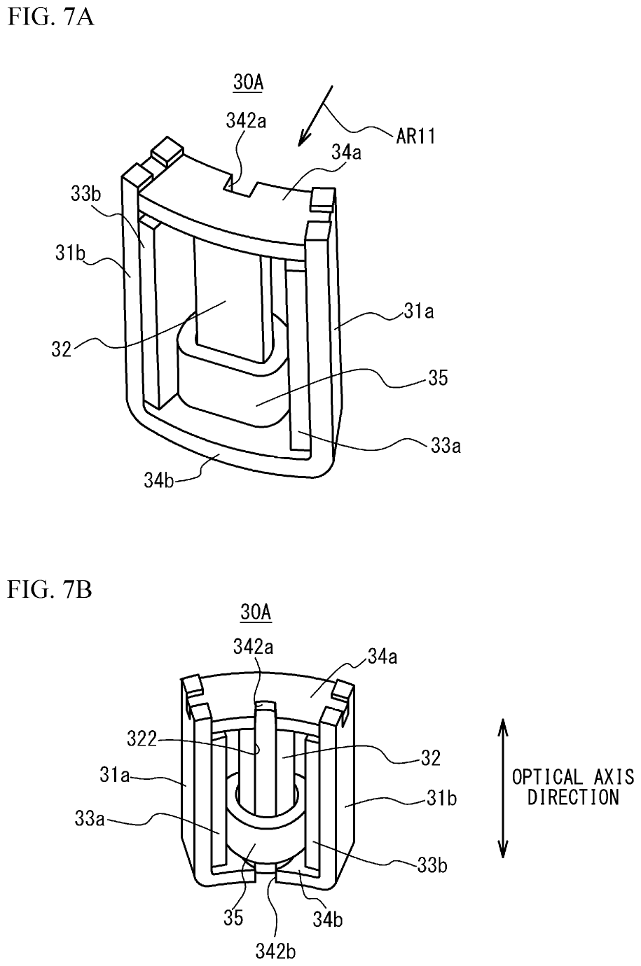

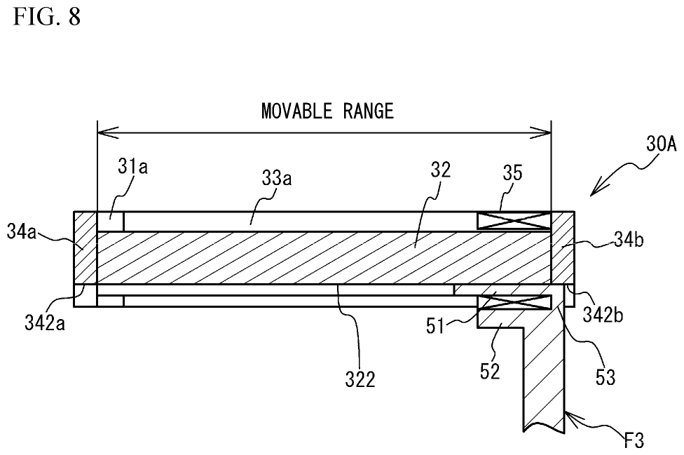

FIG. 7A is a perspective view of a VCM 30A in accordance with a first variation, and FIG. 7B is a view of the VCM 30A as viewed from a direction indicated by an arrow AR11 in FIG. 7A. FIG. 8 is a diagram for describing a movable range of the coil 35 in the VCM 30A in accordance with the first variation.

In the VCM 30A of the first variation, the upper yoke 34a has a recess portion 342a continuous with the groove 322 of the center yoke 32, and the lower yoke 34b has a recess portion 342b continuous with the groove 322 of the center yoke 32. Further, as illustrated in FIG. 8, in order to ensure the rigidity, the length of the first portion 51 of the lens holding frame F3 in the optical axis direction is made longer than that of the coil 35, and the first portion 51 protrudes more to the upper yoke 34a side than the coil 35. Since other configurations are the same as those of the VCM 30 in accordance with the embodiment, detailed description thereof will be omitted.

In the VCM 30A, since the upper yoke 34a has the recess portion 342a continuous with the groove 322, contact between the first portion 51 and the upper yoke 34a is avoided, and the coil 35 can move along the center yoke 32 until the end surface at the upper yoke 34a side of the coil 35 comes into contact with the upper yoke 34a. Since the lower yoke 34b has the recess portion 342b continuous with the groove 322 of the center yoke 32, contact between the connection portion 53 and the lower yoke 34b is avoided, and the coil 35 can move along the center yoke 32 until the end surface at the lower yoke 34b side of the coil 35 comes into contact with the lower yoke 34b. That is, the entire distance between the upper yoke 34a and the lower yoke 34b in the optical axis direction is the movable range of the coil 35. As described above, in the VCM 30A of the first variation, the movable range of the coil 35 can be increased.

In the first variation, the upper yoke 34a and the lower yoke 34b have the recess portions 342a and 342b, respectively. However, at least one yoke may have a recess portion continuous with the groove 322. The recess portions 342a and 342b may not necessarily penetrate through the upper yoke 34a or the lower yoke 34b in the optical axis direction as long as the first portion 51 and the connection portion 53 can be prevented from coming into contact with the upper yoke 34a or the lower yoke 34b before the coil 35.

### Second Variation

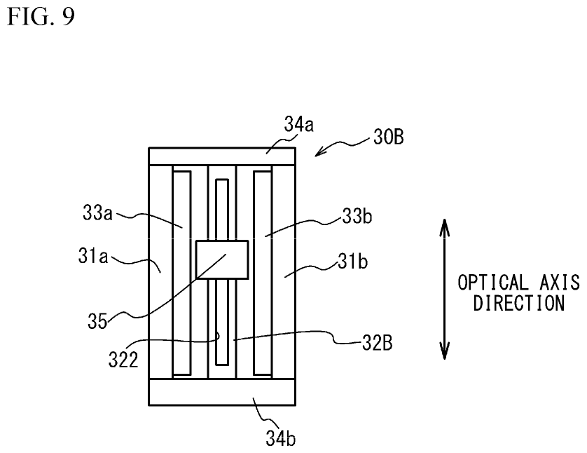

FIG. 9 is a front view illustrating a configuration of a VCM 30B in accordance with a second variation. In the VCM 30B, the groove 322 is not formed in any of end portions of a center yoke 32B in the optical axis direction. Since other configurations are the same as those of the VCM 30, detailed description thereof will be omitted.

In a configuration in which the center yoke 32B is disposed between the first and second side yokes 31a and 31b, the magnetic fluxes from the first and second magnets 33a and 33b disposed on the first and second side yokes 31a and 31b are concentrated on one center yoke 32B. In this case, the density of the magnetic flux becomes high at both end portions of the center yoke 32B in the optical axis direction, and a portion where the magnetic flux hardly flows is generated, and therefore, a desired driving force may not be obtained.

In the second variation, the groove 322 is not formed at any of the end portions of the center yoke 32B in the optical axis direction. As a result, the cross-sectional area of the end portion of the center yoke 32B in the optical axis direction is larger than the cross-sectional area of the central portion in the optical axis direction. As a result, the magnetic flux easily flows at both end portions of the center yoke 32B in the optical axis direction, and the driving force of the VCM 30B can be increased as compared with the case of using the center yoke 32 of the embodiment and the first variation in which the groove 322 is formed at both end portions in the optical axis direction.

In the above embodiment and variations, the coil 35 has a substantially D shape, but the shape is not limited thereto. The coil 35 may have a circular shape. In this case, the center yoke 32, 32B may be a cylinder having the groove 322 along the optical axis direction.

In the above embodiment, the material of the center yoke 32 is different from the materials of the first side yoke 31a and the second side yoke 31b, but may be the same as or different from the materials of the first side yoke 31a and the second side yoke 31b. However, the material of the center yoke 32 is preferably a material having a higher saturation flux density than the materials of the first side yoke 31a and the second side yoke 31b. This improves the flow of magnetic flux in the center yoke 32, and improves the driving force of the VCM 30.

In the above embodiment, the second fixed barrel 20 that houses the lens holding frame F3 may be a movable barrel that is linearly movable in the optical axis direction. In the above embodiment and variations thereof, the lens barrel 100 may be a single-focus lens or a zoom lens. The VCMs 30, 30A, and 30B may be used for other than the lens barrel.

The embodiments described above are examples of preferred implementations. However, the present invention is not limited thereto, and various modifications can be made without departing from the scope of the present invention, and arbitrary constituent elements may be combined.

### DESCRIPTION OF REFERENCE NUMERALS

1 camera
30, 30A, 30B voice coil motor
31a first side yoke
31b second side yoke
32, 32B center yoke
33a first magnet
33b second magnet
34 upper yoke
34b lower yoke
35 coil
51 first portion
52 second portion
53 connection portion
100 lens barrel
101 camera body
322 groove
342a, 342b recess portion
L3 lens
F3 lens holding frame

1. A lens barrel comprising:
a first yoke and a second yoke each having a length in an optical axis direction;
a third yoke that has a length in the optical axis direction and is disposed between the first yoke and the second yoke;
a first magnet disposed on the first yoke;
a second magnet disposed on the second yoke;
a coil that is penetrated by the third yoke and is movable in the optical axis direction by magnetic forces of the first magnet and the second magnet; and
a lens holding frame that holds a lens and is movable together with the coil in the optical axis direction,
wherein the third yoke has a groove along the optical axis direction.

2. The lens barrel according to claim 1, wherein the third yoke has the groove at a side where the lens is disposed.

3. The lens barrel according to claim 1,
wherein the lens holding frame includes a first portion located inside the coil and a second portion that is located outside the coil and sandwiches the coil between the first portion and the second portion, and
wherein the first portion is disposed in the groove and is movable along the groove in the optical axis direction.

4. The lens barrel according to claim 3, wherein the first portion is in contact with an inner peripheral surface of the coil.

5. The lens barrel according to claim 3,
wherein the lens holding frame includes a connection portion that connects the first portion and the second portion, and
wherein the connection portion is located at one end side of the lens holding frame in the optical axis direction.

6. The lens barrel according to claim 5, wherein another end side of the lens holding frame in the optical axis direction does not have the connection portion.

7. The lens barrel according to claim 3, wherein a length of the first portion in the optical axis direction is shorter than a length of the coil in the optical axis direction.

8. The lens barrel according to claim 1, wherein a starting point of winding of the coil faces the groove.

9. The lens barrel according to claim 1, wherein a conductive wire led out from the coil is connected to a substrate attached to the lens holding frame.

10. The lens barrel according to claim 1, wherein the third yoke does not have the groove at any of both end portions thereof in the optical axis direction.

11. The lens barrel according to claim 1, further comprising:
a fourth yoke connecting first ends of the first yoke, the second yoke, and the third yoke in the optical axis direction; and
a fifth yoke connecting second ends of the first yoke, the second yoke, and the third yoke in the optical axis direction,
wherein at least one of the fourth yoke or the fifth yoke includes a recess portion continuous with the groove.

12. An imaging device comprising:
the lens barrel according to claim 1.
